(19) United States
(12) Patent Application Publication
(10) Pub. No.: US 2019/0387921 A1
(43) Pub. Date: Dec. 26, 2019

(54) Forced-Air Food-Heating Apparatus

(71) Applicant: Creator, Inc., San Francisco, CA (US)

(72) Inventors: Adrienne LEMBERGER, Berkeley, CA (US); Michael BALSAMO, San Francisco, CA (US); Maxwell GOODMAN, Oakland, CA (US); Arya BANAIT, San Francisco, CA (US); Thomas HANSON, Napa, CA (US); Devin SPRATT, Sunnyvale, CA (US); Oshin NAZARIAN, San Francisco, CA (US)

(21) Appl. No.: 16/447,911

(22) Filed: Jun. 20, 2019

Related U.S. Application Data
(60) Provisional application No. 62/687,798, filed on Jun. 20, 2018.

(51) Int. Cl. A47J 37/06

(52) U.S. Cl. CPC A47J 37/0641

(57) ABSTRACT

A food-heating apparatus includes a blower assembly, a heater housing, and a heating element. The heater housing may receive air from the blower assembly. The heating element may be disposed within the heater housing. The heater housing may a first flow path through which the air flows in a first direction outside of the heating element. The heating element may define a second flow path through which the air flows in a second direction inside of the heating element. The first flow path may receive the air from the blower assembly. The second flow path may receive the air from the first flow path.

### CROSS-REFERENCE TO RELATED APPLICATIONS

This application claims the benefit of U.S. Provisional Patent Application No. 62/687,798 filed Jun. 20, 2018. The entire disclosure of the application referenced above is incorporated by reference.

### FIELD

The present disclosure relates to a forced-air food-heating apparatus and methods of using the food-heating apparatus.

### BACKGROUND

Preparation of foodstuffs (for example, hamburgers, sandwiches, etc.) according to a consumer's custom order can be time-consuming and labor-intensive. Furthermore, the process of preparing custom-ordered foodstuffs is susceptible to errors and wide variations in quality. The present disclosure provides an automated food preparation system that can quickly and accurately prepare foodstuffs according to a wide variety of possible custom orders with limited human involvement.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This section provides a general summary of the disclosure, and is not a comprehensive disclosure of its full scope or all of its features.

A food-heating apparatus may include a blower assembly, a heater housing, and a heating element. The heater housing may receive air from the blower assembly. The heating element may be disposed within the heater housing. The heater housing may a first flow path through which the air flows in a first direction outside of the heating element. The heating element may define a second flow path through which the air flows in a second direction inside of the heating element. The first flow path may receive the air from the blower assembly. The second flow path may receive the air from the first flow path.

In some configurations of the food-heating apparatus of the above paragraph, the blower assembly is disposed within a blower housing that is attached to the heater housing.

In some configurations, the food-heating apparatus of either of the above paragraphs may include a plurality of heating elements defining the second flow path.

In some configurations, the food-heating apparatus of either of the above paragraphs may include an impingement plate including a plurality of apertures. The impingement plate may define an air outlet of the food-heating apparatus.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The present disclosure will become more fully understood from the detailed description and the accompanying drawings.

FIG. 1 is a schematic representation of an automated food preparation system according to the principles of the present disclosure.

FIG. 2 is a perspective view of a food-heating apparatus of the automated food preparation system of FIG. 1.

FIG. 3 is partial perspective sectional view of a blower assembly of the food-heating apparatus of FIG. 2.

FIG. 4 is a partial perspective sectional view of a heater assembly of the food-heating apparatus of FIG. 2.

FIG. 5 is a sectional view of a perforation of the heater assembly of FIG. 4.

FIG. 6 is an exploded perspective view of the heater assembly of FIG. 4.

FIG. 7A is a functional block diagram showing an example implementation of a food-heating apparatus.

FIG. 7B is a functional block diagram showing an example implementation of a food-heating apparatus.

FIG. 8 is a flowchart showing example control of the food-heating apparatus.

FIG. 9 is a flowchart of another example control scheme for the food-heating apparatus.

FIG. 10 is a flowchart of error handling control for the food-heating apparatus.

FIG. 11 is a perspective view of an alternative food-heating apparatus that can be incorporated into the system of FIG. 1.

FIG. 12 is another perspective view of the food-heating apparatus of FIG. 11.

FIG. 13 is a cross-sectional view of the food-heating apparatus of taken along line 13-13 of FIG. 12.

FIG. 14 is a partial perspective cross-sectional view of the food-heating apparatus.

FIG. 15 is a partial bottom view of the food-heating apparatus.

FIG. 16 is a cross-sectional view of a heating core of the food-heating apparatus.

FIG. 17 is a perspective view of a heating core of the food-heating apparatus.

In the drawings, reference numbers may be reused to identify similar and/or identical elements.

### DETAILED DESCRIPTION

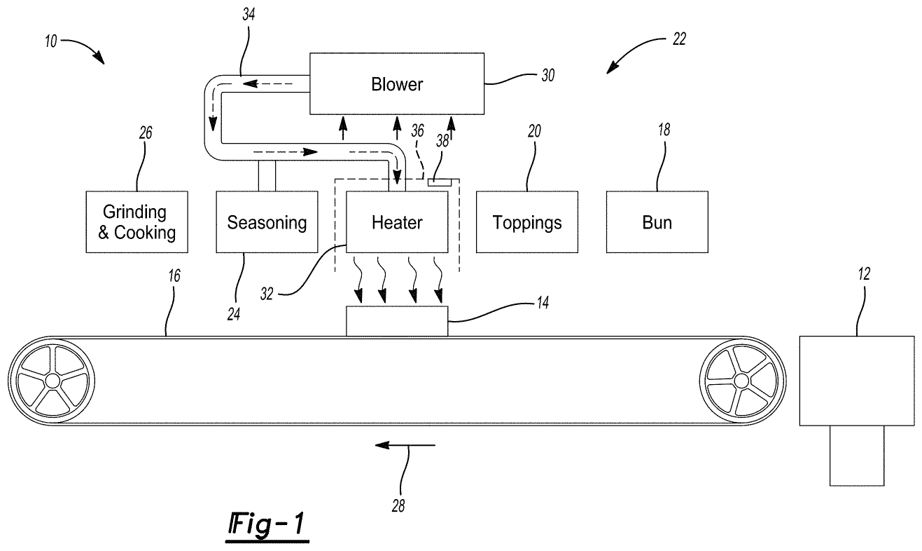

With reference to FIG. 1, an example of an automated food preparation system 10 according to various implementations of the present disclosure is shown. The automated food preparation system 10 includes one or more stations, such as a box-dispensing apparatus 12 for placing a box 14 onto a conveyance system 16. The automated food preparation system 10 further includes a bun-dispensing apparatus 18, a toppings-dispensing apparatus 20, a food-heating apparatus 22, a seasonings apparatus 24, and a grinding and cooking apparatus 26. The conveyance system 16 transports the box 14 in a first direction 28 to deliver it to one or more or the stations. In one example, the box-dispensing apparatus 12 places a box, such as the box 14, on the conveyance system 16.

The bun-dispensing apparatus 18 slices, toasts, and butters a bun, then dispenses the bun in the box 14. The toppings-dispensing apparatus 20 prepares toppings, such as by slicing or grating, and dispenses the toppings on the bun. In various implementations, the toppings-dispensing apparatus 20 grates cheese and dispenses it on the bun. The food-heating apparatus 22 heats the cheese to melt the cheese onto the bun. The seasonings apparatus 24 dispenses seasonings onto the bun. The grinding and cooking apparatus 26 grinds a protein, such as meat, forms a patty, cooks the patty, and deposits it onto the bun. Each of the stations may include multiple subsystems. Furthermore, the automated food preparation system 10 may include different or additional systems and subsystems.

The food-heating apparatus 22 uses forced, heated air to heat foodstuffs, such as to melt cheese. The food-heating apparatus 22 includes a blower assembly 30 and a heater assembly 32. The blower assembly 30 and the heater assembly 32 are fluidly connected by a pipe 34. The pipe 34 may provide a mounting location for other components of the automated food preparation system 10. For example, the seasonings apparatus 24 may be suspended from the pipe 34, so that the pipe 34 provides structural support for the seasonings apparatus 24. The pipe 34 may be formed from or include stainless steel.

The heater assembly 32 is disposed within an enclosure 36. The enclosure 36 may include a plurality of removable panels (not shown) to provide access to the heater assembly 32 for maintenance. One or more of the removable panels may include a window. The enclosure 36 includes three interlock switches 38. When the enclosure 36 is opened by removal of a panel, the interlock switch 38 opens and power to the heater assembly 32 is cut. In alternative implementations, the enclosure surrounds other systems in addition to the food-heating apparatus 22 (not shown). In one example, the enclosure is disposed around both the food-heating apparatus 22 and the seasonings apparatus 24.

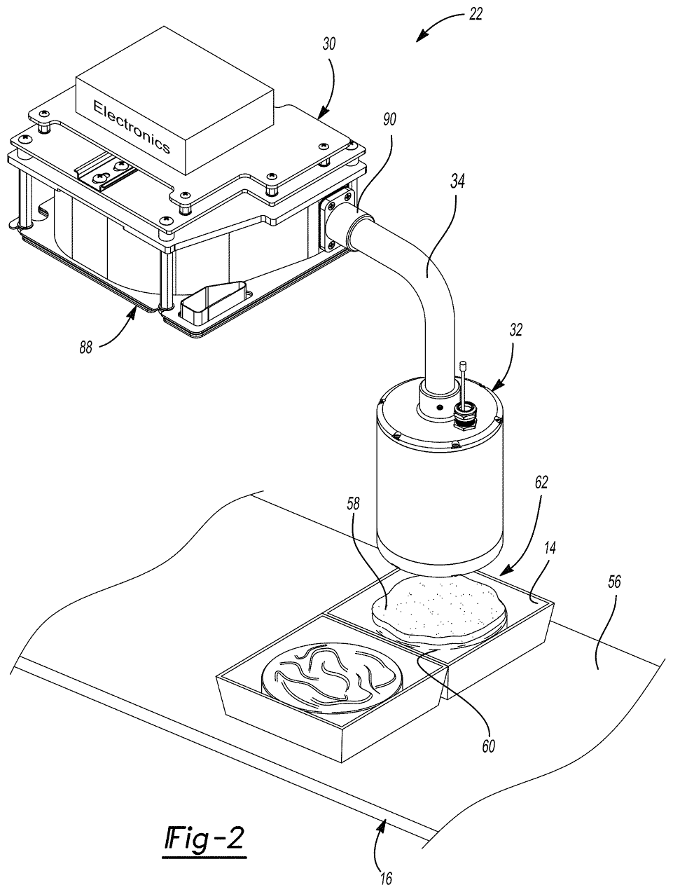

Referring to FIG. 2, an example of the food-heating apparatus 22 according to various implementations of the present disclosure is shown. The food-heating apparatus 22 includes the blower assembly 30 and the heater assembly 32 that are fluidly connected by the pipe 34. The heater assembly 32 is disposed above a surface 56 of the conveyance system 16. Foodstuffs to be heated, such a cheese 58 on a bun 60, may be disposed on the surface 56 below the heater assembly 32. During operation of the food-heating apparatus 22, the blower assembly 30 receives ambient air, filters the ambient air, and discharges filtered air to the heater assembly 32. The heater assembly 32 receives filtered air, heats the filtered air, and discharges the filtered, heated air to heat the foodstuffs, such as the cheese 58 on the bun 60, by convection.

When the food-heating apparatus 22 is in use, a constant predetermined temperature is maintained within the heater assembly 32, regardless of whether foodstuffs are disposed in the heating region 62. The blower assembly 30 is configured to transition between a first or idle state and a second or active state. The blower assembly 30 operates at the idle state when the heating region is free of foodstuffs. In the idle state, the blower assembly 30 may operate at a predetermined idle duty cycle corresponding to a “low fan speed.” The low fan speed is chosen to reduce or eliminate the flow of air from the heater assembly 32 back out through the inlet and toward the blower assembly 30. This prevents hot air from radiating to other components, such as the seasonings apparatus 24. This also prevents rising hot air from carrying particulate matter back to the blower assembly 10.

The blower assembly 30 operates in the active state when foodstuffs are present in the heating region 62. In the active state, the blower assembly 30 may operate at a predetermined active duty cycle corresponding to a “high fan speed.” The terms “high” and “low” are relative, simply indicating that the “high” fan speed is higher than the “low” fan speed. In the active state, the blower assembly 30 forces air into the heater assembly 32 to be heated and then out of the heater assembly 32 to heat the foodstuffs, such as the cheese 58.

Although the blower assembly 30 is shown as being positioned above and to the side of the heater assembly 32, with the pipe 34 bending through a right angle, other configurations are possible. In another example, the blower assembly 30 is positioned at the same height as the heater assembly 32 with respect to the conveyance surface 56 and the pipe 34 includes multiple bends. The food-heating apparatus 22 can be positioned over a different type of surface, such as a stationary surface, to heat different types of foodstuffs. Therefore, although the food-heating apparatus 22 is shown and described in the context of burgers, it can be used to heat any kind of food or other substrate.

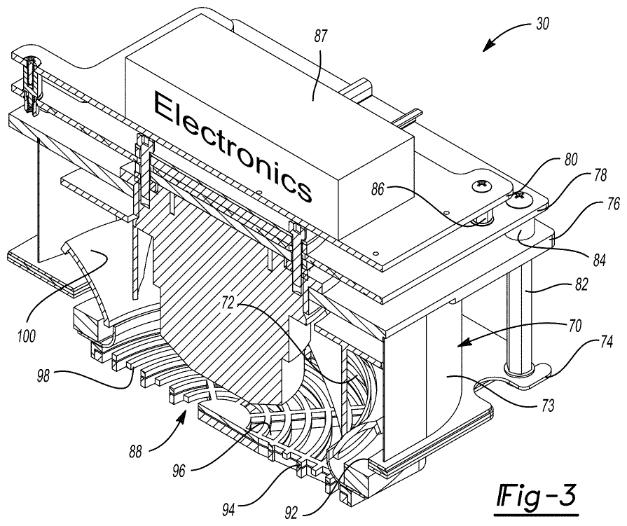

With reference to FIG. 3, the blower assembly 30 is shown. The blower assembly 30 includes a blower housing 70 that at least partially defines an inner area 72. The blower housing 70 includes a side wall 73, a lower wall 74, an upper wall 76, a first platform 78, and a second platform 80. A first plurality of pillars 82 extends between the lower wall 74 and the upper wall 76. A second plurality of pillars 84 extends between the upper wall 76 and the first platform 78. A third plurality of pillars 86 extends between the first platform 78 and the second platform 80. An electronics subassembly 87, shown schematically, is at least partially disposed on the second platform 80.

The inner area 72 includes an air inlet 88 and an air outlet 90 (FIG. 2). The air inlet 88 includes an aperture 92 defined in the lower wall 74. A grate 94 is disposed across the aperture 92. The grate 94 supports a filter 96. The grate 94 defines a plurality of openings 98 through which air can flow. The grate 94 may be formed from or include stainless steel. The filter 96 is a particulate filter that is configured to comply with regulations regarding air that comes in contact with foodstuffs (for example, NSF 51).

A fan 100 is disposed within the inner area 72 and configured to rotate with respect to the blower housing 70. During operation of the blower assembly 30, the fan 100 draws air through the filter 96 and into the inner area 72 as it rotates. The filtered air in the inner area 72 is discharged through the air outlet 90 (FIG. 2). The fan 100 may be a centrifugal fan, an axial fan, or a cross-flow fan. The fan 100 may be selected for its ability to produce high pressure to contend with head losses associated with the filter 96, pipe 34, and heater assembly 32 (especially, the stagnation chamber 248 described below).

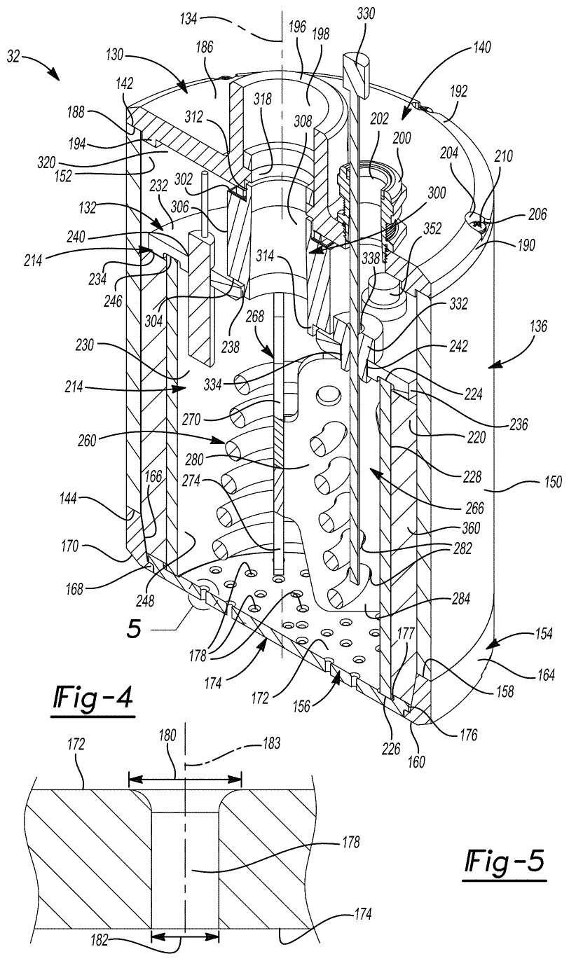

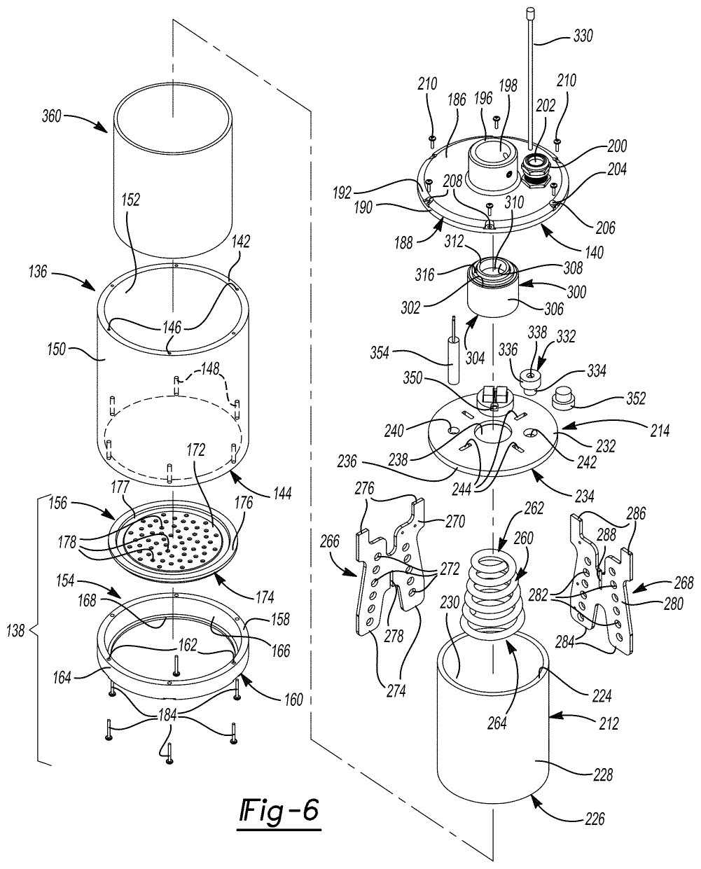

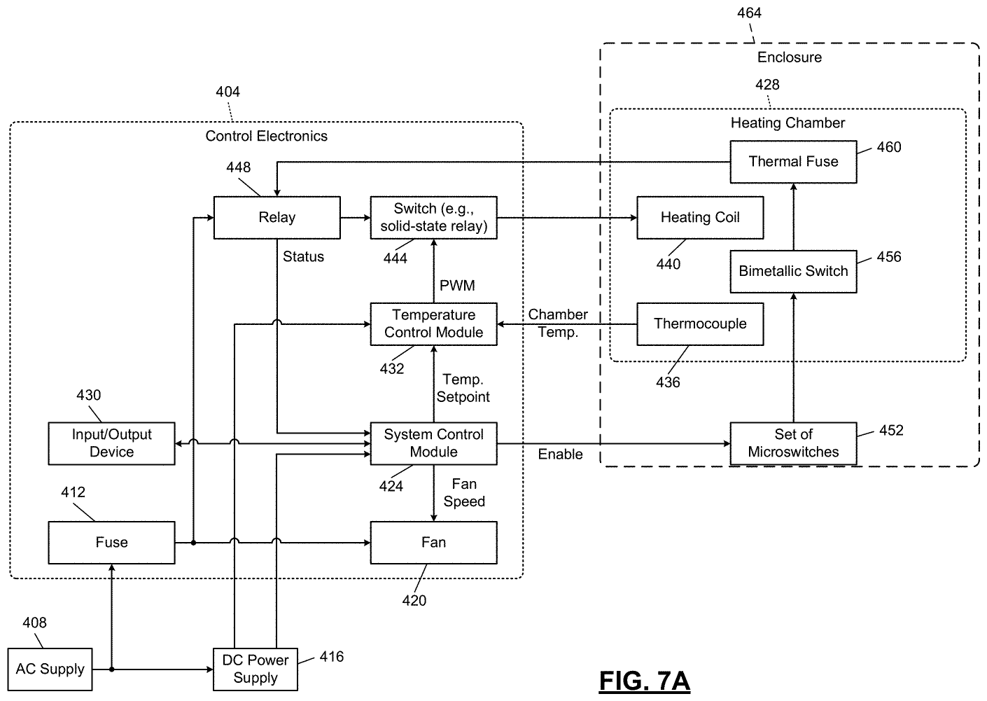

Referring to FIGS. 4-6, the heater assembly 32 is shown. The heater assembly 32 includes an outer housing 130 and an inner housing 132 that is disposed within the outer housing 130 (FIG. 4). The outer housing 130 and the inner housing 132 are aligned along a longitudinal axis 134 (FIG. 4). The outer housing 130 includes a first or outer cylindrical wall 136, a base 138, and a cap 140. The outer cylindrical wall 136 includes a first top surface 142 and a first bottom surface 144 opposite the first top surface 142. The first top and bottom surfaces 142, 144 are annular. The first top surface 142 defines a first plurality of apertures 146 (FIG. 6) configured to engage a plurality of fasteners (such as fasteners 210). The apertures 146 may be threaded. The first bottom surface 144 defines a second plurality of apertures 148 (FIG. 6) configured to engage a plurality of fasteners (such as fasteners 184). The apertures 148 may be threaded. The outer cylindrical wall 136 further includes a first outer surface 150 and a first inner surface 152.

The base 138 includes an annular rim 154 and an impingement plate 156. The annular rim 154 includes a second top surface 158 and a second bottom surface 160 opposite the second top surface 158. A third plurality of apertures 162 (FIG. 6) extends between the second top surface 158 and the second bottom surface 160. The apertures 162 may be through holes configured to receive fasteners (such as fasteners 184). The annular rim 154 includes a second outer surface 164 and a second inner surface 166. The annular rim 154 further includes a first lip 168 that extends radially inwardly from the second inner surface 166. The second bottom surface 160 extends across the first lip 168. A first annular chamfer 170 extends between the second outer surface 164 and the second bottom surface 160.

The plate 156 is at least partially disposed within the annular rim 154. The plate 156 includes a third top surface 172 and a third bottom surface 174. The plate 156 includes a second lip 176 that projects from the third top surface 172 and extends radially outwardly from a periphery of the plate 156. The second lip 176 of the plate 156 engages the first lip 168 of the annular rim 154 so that the plate 156 is retained within a center of the annular rim 154. The second bottom surface 160 of the annular rim 154 and the third bottom surface 174 of the plate 156 cooperate to form a coplanar surface. The third top surface 172 defines a first annular groove 177. The first annular groove 177 is disposed radially inwardly of the second lip 176.

A plurality of apertures or perforations 178 extends between the third top surface 172 and the third bottom surface 174 of the plate 156. During operation of the food-heating apparatus 22, heated air exits the heater assembly 32 through the plurality of perforations 178. As shown in FIG. 5, the perforations 178 may be chamfered. That is, the perforations 178 may define a first diameter 180 adjacent to the third top surface 172 and a second diameter 182 adjacent to the third bottom surface 174. The first diameter 180 has a greater magnitude than the second diameter 182. The geometry of the perforations 178 facilitates the flow of air from inside the heater assembly 32 out through the perforations 178. Each perforation 178 extends along a perforation axis 183 that is substantially perpendicular to the longitudinal axis 134 of the heater assembly 32. However, in various alternative embodiments the perforations may extend nonparallel to the longitudinal axis 134 and/or nonparallel to one another.

A first plurality of fasteners 184 (FIG. 6) extends through the third plurality of apertures 162 in the annular rim 154 and into the second plurality of apertures 148 in the first cylindrical wall, respectively, to couple the base 138 to the outer cylindrical wall 136. The fasteners 184 may be threaded and configured to engage mating threads of the apertures 148 of the second plurality.

The cap 140 includes a fourth top surface 186, a fourth bottom surface 188 opposite the fourth top surface 186, and a third outer surface 190. A second annular chamfer 192 extends between the fourth top surface 186 and the third outer surface 190. An annular axial projection 194 (FIG. 4) extends from the fourth bottom surface 188. The annular axial projection 194 is disposed radially inwardly of a periphery of the cap 140.

The cap 140 includes a first neck 196 that projects axially from the fourth top surface 186. The first neck 196 is radially centered and defines a first opening 198 that is centrally disposed and aligned with the longitudinal axis 134. The first neck 196 is fluidly connected to the pipe 34 to receive filtered air from the blower assembly 30. Thus, the first neck 196 is an inlet to the heater assembly 32. The cap 140 further includes a second neck 200 that projects axially from the fourth top surface 186. The second neck 200 is disposed at an intermediate radially location between the first neck 196 and the second annular chamfer 192. The second neck 200 defines a second opening 202.

The second annular chamfer 192 defines a plurality of counterbores 204 to provide clearance for heads of fasteners (such as fasteners 210). Each counterbore 204 includes a respective notch surface 206. The notch surfaces 206 define respective fourth plurality of apertures 208 (FIG. 6). The cap 140 is disposed on the outer cylindrical wall 136. The annular axial projection 194 of the cap 140 locates the cap 140 with respect to the outer cylindrical wall 136. The annular axial projection 194 engages the first inner surface 152 of the outer cylindrical wall 136. The fourth bottom surface 188 of the cap 140 engages the first top surface 142 of the outer cylindrical wall 136. A second plurality of fasteners 210 extends through the fourth plurality of apertures 208 in the cap 140 and into the first plurality of apertures 146 of the outer cylindrical wall 136 to couple the cap 140 to the outer cylindrical wall 136. The fasteners 210 of the second plurality may be threaded and may engage mating threads of the apertures 146 of the first plurality.

The inner housing 132 includes a second or inner cylindrical wall 212, and a partition 214. The inner cylindrical wall 212 includes a fifth top surface 224 a fifth bottom surface 226 opposite the fifth top surface 224, a fourth outer surface 228, and a third inner surface 230. The inner cylindrical wall 212 may be formed from or include a ceramic (for example, Mullite).

The partition 214 includes a sixth top surface 232, a sixth bottom surface 234 opposite the sixth top surface 232, and a fifth outer surface 236. The partition 214 includes a third opening 238 that is centrally disposed and aligned with the longitudinal axis 134.

The partition 214 further includes a first partition aperture 240 and a second partition aperture 242. The first and second partition apertures 240, 242 are disposed at substantially the same radii with respect to the longitudinal axis 134. The first and second partition apertures 240, 242 are substantially equally circumferentially spaced about the longitudinal axis 134. Thus, the first and second partition apertures 240, 242 are disposed about 180° from one another about the longitudinal axis 134. The partition 214 further defines a plurality of axial slots 244 (FIG. 6). The axial slots 244 of the plurality are disposed at substantially the same radii with respect to the longitudinal axis 134. The axial slots 244 of the plurality are substantially equally circumferentially spaced about the longitudinal axis 134. Thus, the axial slots 244 are disposed about 90° from one another about the longitudinal axis 134. Each of the first partition aperture 240, the second partition aperture 242, and the axial slots 244 extend between the sixth top surface 232 and the sixth bottom surface 234.

The sixth bottom surface 234 defines a second annular groove 246 (FIG. 4). The second annular groove 246 is disposed radially inwardly of a periphery of the sixth bottom surface 234. The inner cylindrical wall 212 is partially disposed within the second annular groove 246. Specifically, the fifth top surface 224 of the inner cylindrical wall engages a surface of the second annular groove 246. The fifth bottom surface 226 of the inner cylindrical wall 212 engages the third top surface 172 of the plate 156. The inner housing 132 and the plate 156 cooperate to define a stagnation chamber 248 (FIG. 4).

The heater assembly 32 further includes a heating coil 260 that is disposed within the stagnation chamber 248. The heating coil 260 is a wire that generally forms a frusto-conical shape. Thus, the frusto-conical shape defines a smaller diameter on a first end 262 and a larger diameter on a second end 264 (FIG. 6). The heating coil 260 heats air within the stagnation chamber 248. As air is heated, it flows out of the stagnation chamber 248 through the perforations 178 of the plate 156. The porosity of the plate 156, that is, total area of the perforations divided by surface area of the plate 156, affects heat transfer from the heating coil 260 to the air. When the porosity is lower, flow within the stagnation chamber 248 is laminar and heat transfer is higher.

The heating coil 260 is fixed by a first radial support 266 and a second radial support 268. As shown in FIG. 6, the first radial support 266 includes a first planar wall 270 that defines a fifth plurality of apertures 272. The first planar wall 270 includes two first feet 274 disposed at a top end and two first tabs 276 disposed at a bottom end opposite the top end. The first planar wall 270 defines a first axial slit 278 that extends upward between the first feet 274. The second radial support 268 includes a second planar wall 280 that defines a sixth plurality of apertures 282. The second planar wall 280 includes two second feet 284 disposed at a top end of the second planar wall 280 and two second tabs 286 disposed at a bottom end of the second planar wall 280 opposite the top end. The second planar wall 280 defines a second axial slit 288 that extends downward between the second tabs 286.

Except for the locations of the fifth and sixth pluralities of apertures 272, 282 and the first and second axial slits 278, 288, the shapes and sizes of the first and second radial supports 266, 268 are substantially the same. The first and second radial supports 266, 268 cooperate to form a fixture that supports the heating coil 260. Specifically, the first axial slit 278 of the first radial support 266 engages the second axial slit 288 of the second radial support 268. Thus, the first and second planar walls 270, 280 are disposed substantially perpendicular to one another and define an X-shaped cross section substantially perpendicular to the longitudinal axis 134. The heating coil 260 alternatingly extends through the apertures 272 of the fifth plurality and the apertures 282 of the sixth plurality.

The heating coil 260 is centered with respect to the longitudinal axis 134. The first and second feet 274, 284 engage the third top surface 172 of the plate 156. The first and second tabs 276, 286 are received by the axial slots 244 of the partition 214. The engagement of the first and second tabs 276, 286 with the partition 214 couples the first and second radial supports 266, 268, and therefore also the heating coil 260, to the inner housing 132.

A spacer 300 is disposed axially between the cap 140 and the partition 214. The spacer 300 has a generally cylindrical shape. The spacer 300 includes an seventh top surface 302, a seventh bottom surface 304 opposite the seventh top surface 302, a sixth outer surface 306, and a fifth inner surface 308. The fifth inner surface 308 defines a passage 310 (FIG. 6). A third lip 312 extends axially from the seventh top surface 302. A fourth lip 314 (FIG. 4) extends axially from the seventh bottom surface 304.

The spacer 300 is partially disposed within the first opening 198 of the first neck 196. The spacer 300 includes a step 316 that extends axially from the seventh top surface 302. The first neck 196 includes an annular radial projection 318 (FIG. 4) that extends radially inwardly from a surface of the first opening 198. The third lip 312 of the spacer 300 engages the annular radial projection 318 of the first neck 196. Thus, the third lip 312 is at least partially disposed within the first opening 198. The step 316 of the spacer 300 engages the fourth bottom surface 188 of the cap 140. The fourth lip 314 of the spacer 300 is at least partially disposed within the third opening 238 of the partition 214. The seventh bottom surface 304 of the spacer 300 engages the sixth top surface 232 of the partition 214. The spacer 300, the outer cylindrical wall 136, the cap 140, and the partition 214 cooperate to at least partially define an annular upper chamber 320 (FIG. 4).

The heater assembly 32 further includes a thermocouple 330 that is configured to measure a temperature of the air in the stagnation chamber 248. The thermocouple 330 extends from an area adjacent to the heating coil 260 within the stagnation chamber 248, through the second partition aperture 242 and into the annular upper chamber 320, through the second neck 200, and outside of the heater assembly 32. As will be discussed in greater detail below, temperature as measured by the thermocouple 330 is used in closed-loop temperature control. The thermocouple 330 may be a metal thermocouple disposed within a flexible housing. The thermocouple 330 is coupled to the partition 214 by an annular grip 332.

The annular grip 332 includes a shaft 334, a shoulder 336 that extends radially outwardly from the shaft 334, and a fourth opening 338. The shaft 334 is disposed within the second partition aperture 242. The shoulder 336 engages the sixth top surface 232 of the partition 214 to maintain the annular grip 332 within the second partition aperture 242. The thermocouple 330 extends through the fourth opening 338. The thermocouple 330 engages a surface of the fourth opening 338 to couple the thermocouple 330 to the partition 214 (such as by friction).

The heater assembly 32 includes a terminal distribution block 350 (FIG. 6), a reversible bimetallic switch 352, and a thermal fuse 354. The bimetallic switch 352 is disposed on the sixth top surface 232 of the partition 214. The bimetallic switch 352 provides resettable thermal runaway protection. The thermal fuse 354 is at least partially disposed within the first partition aperture 240. The thermal fuse 354 provides backup to the bimetallic switch 352. Wires (not shown) for each of the electrical components enter the heater assembly 32 through the second opening 202 of the second neck 200. Outside of the heater assembly 32, the wires may extend parallel to the pipe 34 within a flexible, rubberized tube. The tube may be pinched at the second neck 200. The wires may be ceramically insulated inside the heater assembly 32.

As shown in FIG. 4, the outer cylindrical wall 136, the inner cylindrical wall 212, and the partition 214 at least partially define a second gap 356. The second gap 356 is annular. The second gap 356 is filled with insulation 360, such as ceramic wool. The annular upper chamber 320 is also filled with insulation (not shown) that is disposed around the thermal fuse 354, the bimetallic switch 352, and thermocouple 330, and the annular grip 332. The heater assembly 32 may include different or additional components that are not shown, such as heat sync and/or additional fasteners, by way of example.

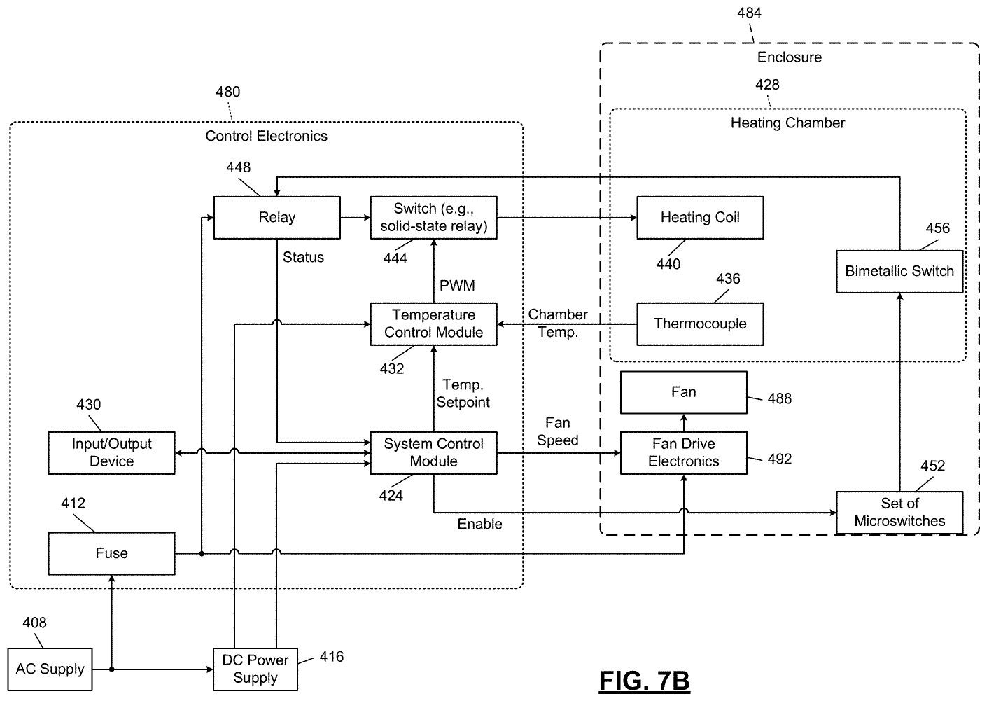

In FIG. 7A, control electronics 404 receives alternating current (AC) power from an AC supply 408. For example, the AC power may be received by a fuse 412 of the control electronics 404. For example, the fuse may be rated at 10 Amps. A direct current (DC) power supply 416 provides DC power to the control electronics 404. As shown in FIG. 7A, the DC power supply 416 may convert AC power from the AC supply 408 into DC power.

A fan 420 receives AC power via the fuse 412. The fan 420 operates according to a fan speed signal from a system control module 424. For example, the fan speed signal may be an analog or digital signal, and may select one of a predetermined set of speeds or may select a speed within a continuously variable spectrum.

The fan 420 includes a motor as well as control circuitry to run the motor at the speed commanded by the system control module 424. Though not shown in FIG. 7A, the fan 420 is mechanically coupled to a heating chamber 428 so that the fan 420 can blow air into and through the heating chamber 428.

An input/output device 430 may be implemented to display setpoints to an operator and/or to allow an operator to adjust setpoints. For example, the input/output device 430 may include a display (such as a seven-segment display) for each of one or more temperature setpoints. The input/output device 430 may also include a display for a measured temperature. The input/output device 430 may include inputs to allow adjustment of one or more temperature setpoints. For example, for each adjustable temperature setpoint, the input/output device 430 may include an up button and a down button that respectively increase and decrease the temperature setpoint by a predetermined increment for each button press. The system control module 424 interfaces with the input/output device 430.

As an example only, the system control module 424 may be implemented using a LINUX computing platform running custom control software according to the principles of the present disclosure. The system control module 424 receives DC power from the DC power supply 416. For example, the DC power may be at a level of approximately 24 Volts. The DC power supply 416 also provides power to a temperature control module 432. In various implementations, the same 24-V DC power may be provided to both the system control module 424 and the temperature control module 432.

The system control module 424 provides a temperature setpoint to the temperature control module 432. The temperature control module 432 performs closed-loop control to maintain a temperature of the heating chamber 428, as measured by a thermocouple 436, at approximately the temperature setpoint. For example only, the temperature control module 432 may implement proportional-integral-derivative closed-loop control.

The temperature control module 432 modulates a heating coil 440 to introduce heat into the heating chamber 428 to achieve the temperature setpoint. The temperature control module 432 may output a pulse-width-modulated (PWM) signal to a switch 444. For example, the switch 444 may be a solid-state relay or a power metal-oxide-semiconductor field-effect transistor (MO SFET).

Under control of the PWM signal, the switch 444 selectively connects AC power received via the fuse 412 and a relay 448 to the heating coil 440. In other implementations, the temperature control module 432 may supply a variable voltage to the switch 444 to modulate the amount of current flowing to the heating coil 440. In various implementations, the temperature control module 432 may be a custom application specific integrated circuit or a microcontroller with custom temperature control software or firmware that allows for high responsiveness and low jitter temperature control.

The relay 448 may, for safety purposes, be a normally-open relay that is closed by an enable signal from the system control module 424. In various implementations, the enable signal from the system control module 424 may pass through a series configuration of protection devices before arriving at the relay 448. Therefore, if any of the protection devices or any of the connecting wiring opens (causes an open circuit), the relay 448 will open, preventing power from reaching the heating coil 440.

In the example of FIG. 7A, the enable signal from the system control module 424 passes through a set of microswitches 452, a bimetallic switch 456, and a thermal fuse 460 before reaching the relay 448. Although described in this order, the order may differ in various implementations. More or fewer protection devices may be introduced in series.

The set of microswitches 452 is one or more microswitches that detect whether protective portions of an enclosure 464 are in place around the heating chamber 428. For example, the enclosure 464 may include one or more heat shielding pieces, each of which may be sensed by one of the set of microswitches 452. In addition, the enclosure 464 may have a door for servicing the heating chamber 428. Whether the door is open may be sensed by one of the set of microswitches 452.

The bimetallic switch 456 opens when the temperature of the heating chamber 428 exceeds a threshold temperature. After the temperature of the heating chamber 428 falls back below the threshold temperature, the bimetallic switch 456 relaxes into a closed state. Meanwhile, the thermal fuse 460 opens when the temperature of the heating chamber 428 exceeds a second temperature threshold. In various implementations, the second temperature threshold is chosen to be higher than the temperature threshold of the bimetallic switch 456.

The thermal fuse 460 does not reset once the heating chamber 428 cools down. Instead, the thermal fuse 460 may need to be manually reset or replaced by an operator. A status of the relay 448 is sensed by the system control module 424. In this way, the system control module 424 can identify when the enable signal is not reaching the relay 448 and can infer that one of the temperature protections or access restrictions has been tripped. The system control module 424 can then control the temperature control module 432 and the fan 420 accordingly. For example, as described in more detail below, the system control module 424 may halt current to the heating coil 440.

In FIG. 7B, another example implementation of a food heating apparatus is shown. Elements of FIG. 7B that are similar to those of FIG. 7A are labeled with the same reference numeral. In FIG. 7B, the thermal fuse 460 may be omitted with respect to FIG. 7A. In addition, control electronics 480 may omit the fan 420 and instead an enclosure 484 may include a fan 488 driven by fan drive electronics 492. In other respects, FIG. 7B may be implemented similarly to FIG. 7A.

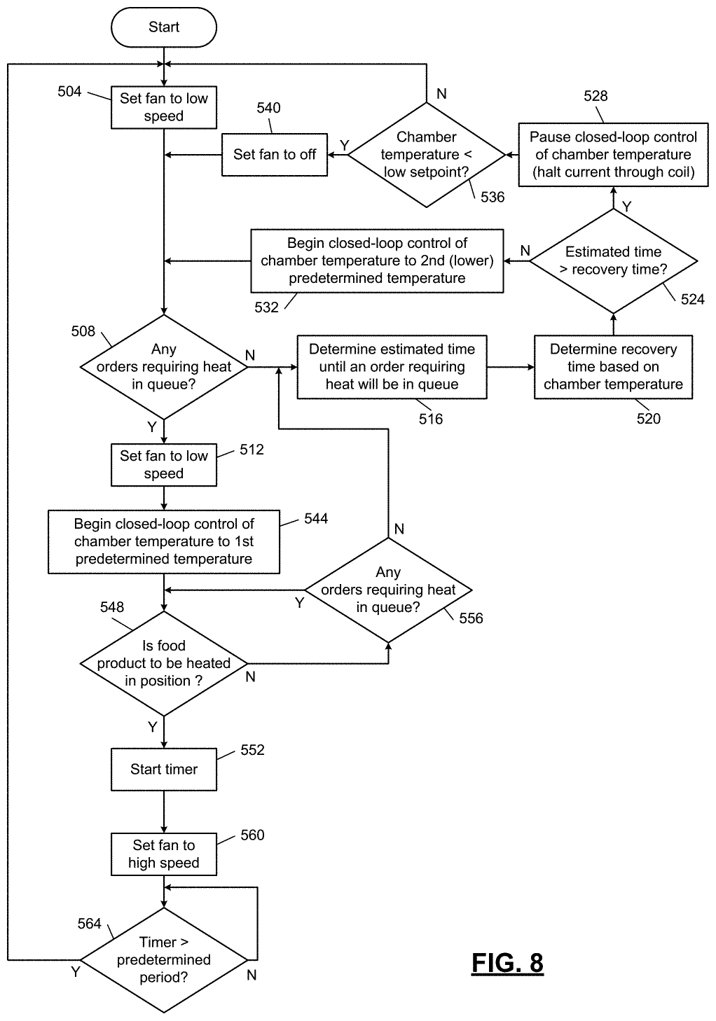

In FIG. 8, a control method is described, which may be implemented by the system control module 424 of FIG. 7A or FIG. 7B. Control begins at 504, where control sets the fan to operate at a predetermined low speed. The term “low” simply means that the low speed is lower than a “high” speed referenced later.

Control continues at 508, where control determines whether there are any orders in the queue of the food processing robot that will require heating. If so, control transfers to 512; otherwise, control transfers to 516. At 516, control determines an estimated time until an order requiring heating will be in the queue. For example, if the robot has been shut down, the estimated time will be at least equal to the robot startup time. If a repair is being conducted, an expected duration for the repair may be added to the robot startup time to arrive at the estimated time.

At 520, control determines a recovery time based on the current chamber temperature. The recovery time is an estimation of how long it would take to return the chamber temperature to a first predetermined temperature (the operating temperature). In other words, the recovery time is an estimate of how long it would take before the food-heating apparatus could resume food heating.

At 524, control determines whether the estimated time is longer than the recovery time. If so, control transfers to 528; otherwise, control transfers to 532. At 528, control pauses closed-loop control of the chamber temperature. In other words, control halts current flowing through the heating coil. Control then continues at 536. At 536, control determines whether the chamber temperature is now below a low setpoint. If so, control transfers to 540; otherwise, control transfers to 504. At 540, the chamber temperature is now low enough that the fan can be set off. Control then continues at 508. At 532, control begins closed-loop control of the chamber temperature to reach a second predetermined temperature that is lower than the first predetermined temperature. Control then continues at 508.

At 512, the queue includes at least one order that will require heat. Control therefore sets the fan to low speed and continues at 544. At 544, control begins closed-loop control of the chamber temperature to the first predetermined temperature. The first predetermined temperature is set so that air within the heating chamber is hot enough that the air, when exhausted, will raise the food to a desired temperature. For example, the desired temperature may be a melting temperature. As one example, the food may be a dairy product such as cheese, and the desired temperature corresponds to a melting point of the cheese.

At 548, control determines whether the food product to be heated is in position underneath the heating chamber. If so, control transfers to 552; otherwise, control transfers to 556. At 556, control determines whether there are any orders requiring heat in the queue. If so, control returns to 548. Otherwise, the order or orders that were identified previously at 508 must have been removed from the queue and therefore control transfers to 516.

At 552, control starts a timer. Control continues at 560, where control sets the fan to high speed to exhaust the heated air from the heating chamber towards the food. Control continues at 564, where if the timer is greater than a predetermined period of time, control returns to 504. Otherwise, control remains at 564 until the predetermined period of heating has concluded.

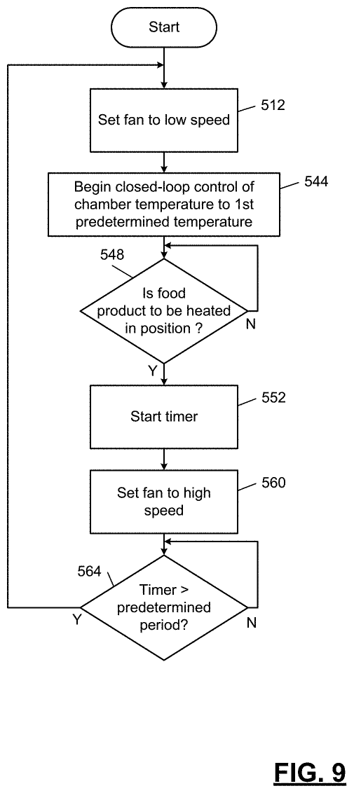

In FIG. 9, a simpler control strategy than that of FIG. 8 is shown. Elements of FIG. 9 that are similar to those of FIG. 8 are labeled with the same reference numeral. In FIG. 9, control begins at 512. At 548, if the food product to be heated is not yet in position, control remains at 548. In other respects, control of FIG. 9 may be similar to that of FIG. 8.

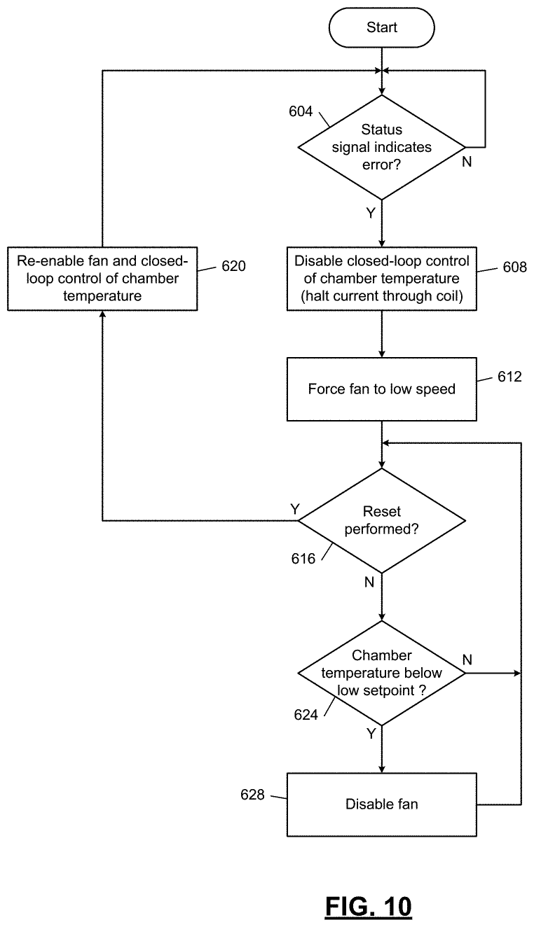

In FIG. 10, error handling control is shown. The error handling control may operate at the system control module 424 in parallel to the control of FIG. 8 or FIG. 9. Control begins at 604, where control determines whether a status signal indicates an error. If the status signal indicates an error, control transfers to 608; otherwise, control remains at 604. The status signal may be received from the relay 448 as shown in FIGS. 8A-8B. In other implementations, other status signals indicating errors may be alternatively or additionally received.

At 608, control disables closed-loop control of the chamber temperature, halting current through the heating coil. At 612, control forces the fan to operate at low speed. At 616, control determines whether a reset has been performed. For example, this may take the form of an operator intervention or a signal from a robot controller requesting a reset. If a reset has been performed, control transfers to 620; otherwise, control transfers to 624.

At 620, control re-enables the fan and re-enables closed-loop control of the chamber temperature. The control of FIG. 8 or of FIG. 9 may then proceed as normal. In other words, forcing the closed-loop control to be disabled and overriding the fan to run at low speed are both ended at 620. Control then returns to 604. At 624, a reset is not yet performed and therefore control tests whether the chamber temperature is below a low setpoint. For example, the low setpoint may be the same as that in 536 of FIG. 8. If the chamber temperature is below the low setpoint, control transfers to 628; otherwise, control returns to 616. At 628, control disables the fan and returns to 616.

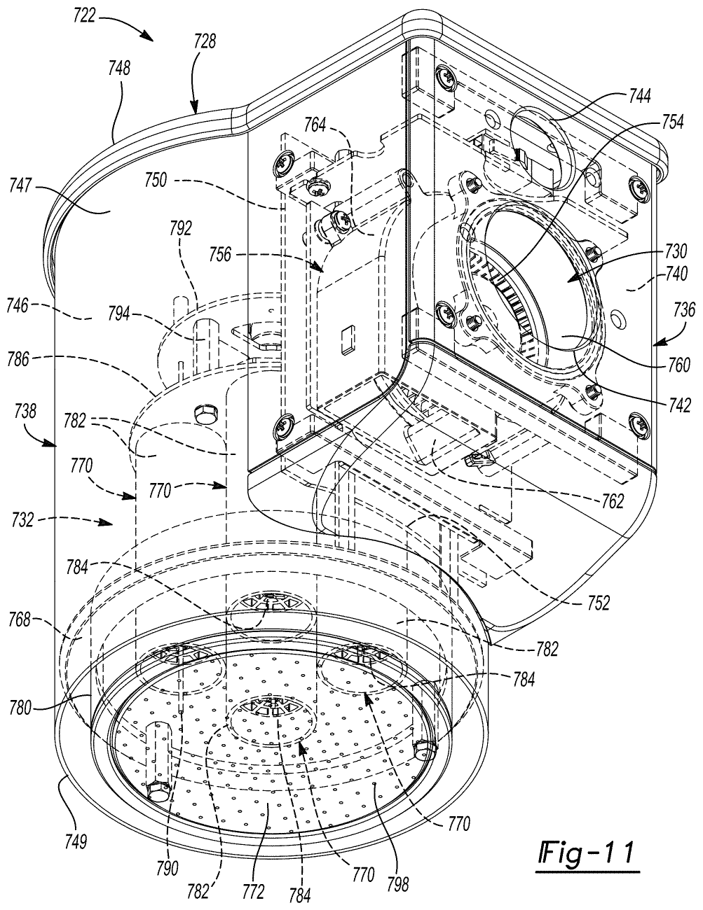

Referring now to FIGS. 11-17, an alternative food-heating apparatus 722 is provided that can be incorporated into the system 10 instead of the food-heating apparatus 22 described above.

The food-heating apparatus 722 includes a housing assembly 728, a blower assembly 730 and a heater assembly 732. The food-heating apparatus 722 can be mounted such that the heater assembly 732 is arranged at least partially within the enclosure 36 and above the surface 56 of the conveyance system 16. As described above, foodstuffs to be heated, such a cheese 58 on a bun 60, may be disposed on the surface 56 below the heater assembly 732. During operation of the food-heating apparatus 722, the blower assembly 730 receives ambient air and discharges air to the heater assembly 732. The heater assembly 732 heats the air, and discharges the heated air onto the foodstuffs, such as the cheese 58 on the bun 60, to heat the foodstuffs by convection.

As shown in FIGS. 11-13, the housing assembly 728 may include a blower housing 736 and a heater housing 738. The blower housing 736 and the heater housing 738 can be integrally formed as a single unit or formed separately and mounted to each other. In some configurations, the blower housing 736 may be separate from and spaced apart from the heater housing 738, and a hose or pipe (like the pipe 34 described above) may transmit air from the blower assembly 730 to the heater assembly 732.

The blower housing 736 may define a first internal cavity 740, an air inlet aperture 742, and a wire aperture 744. The blower assembly 730 is disposed within the first internal cavity 740 and receives ambient air from the air inlet aperture 742. In some configurations, the blower assembly 730 draws air from within the enclosure 36 through the air inlet aperture 742. In other configurations, a pipe (like pipe 34) may be connected to the air inlet aperture 742 and may extend through an opening in the enclosure 36 so that the blower assembly 730 can draw air from outside of the enclosure 36. While not shown in the figures, wires connected to the heater assembly 732 and the blower assembly 730 may extend through the wire aperture 744 to connect the heater assembly 732 and/or the blower assembly 730 to a source of electrical power and/or the system control module 424.

The heater housing 738 may be generally cylindrical and may define a second internal cavity 746 in which the heater assembly 732 is disposed. The heater housing 738 may be closed off at a first axial end 747 by an end cap 748 (which may also close off an end of the blower housing 736). The heater housing 738 may include an open second axial end 749 through which the heater assembly 732 discharges heated air. A partition plate 750 may be disposed between the heater housing 738 and the blower housing 736 and may generally separate the first internal cavity 740 from the second internal cavity 746. A lower end of the partition plate 750 may define an opening 752 that provides communication between the first and second internal cavities 740, 746. That is, the blower assembly 730 forces air through the opening 752 to the second internal cavity 746 of the heater housing 738.

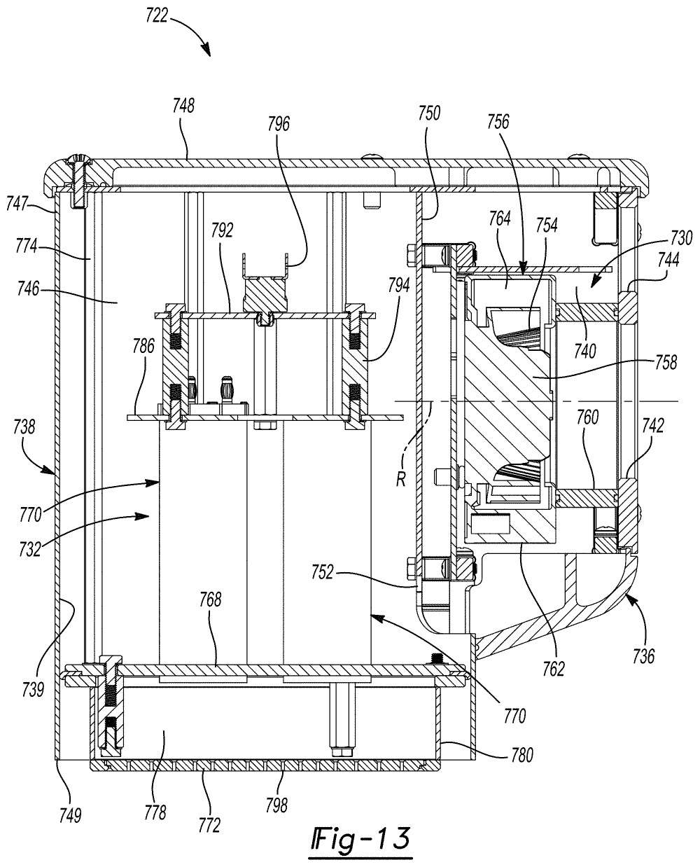

The blower assembly 730 may include a fan 754, a fan shroud 756, and a fan motor 758. The fan 754 may be an axial fan and may be disposed within the shroud 756. The motor 758 may be drivingly coupled to the fan 754 and may be operable to drive the fan at multiple speeds. The shroud 756 may include an inlet 760 that is generally aligned with the air inlet aperture 742 of the blower housing 736. A longitudinal axis of the inlet 760 of the shroud 756 may be parallel to or collinear with a rotational axis R of the fan 754 (see FIG. 13). The fan shroud 756 also includes an outlet 762 that may direct air from the fan 754 in a direction generally perpendicular to the inlet 760 toward the opening 752 to the second internal cavity 746 of the heater housing 738. A body of the shroud 756 may define a generally spiral-shaped or scroll-shaped duct 764 that channels air from the fan 754 to the outlet 762 of the shroud 756.

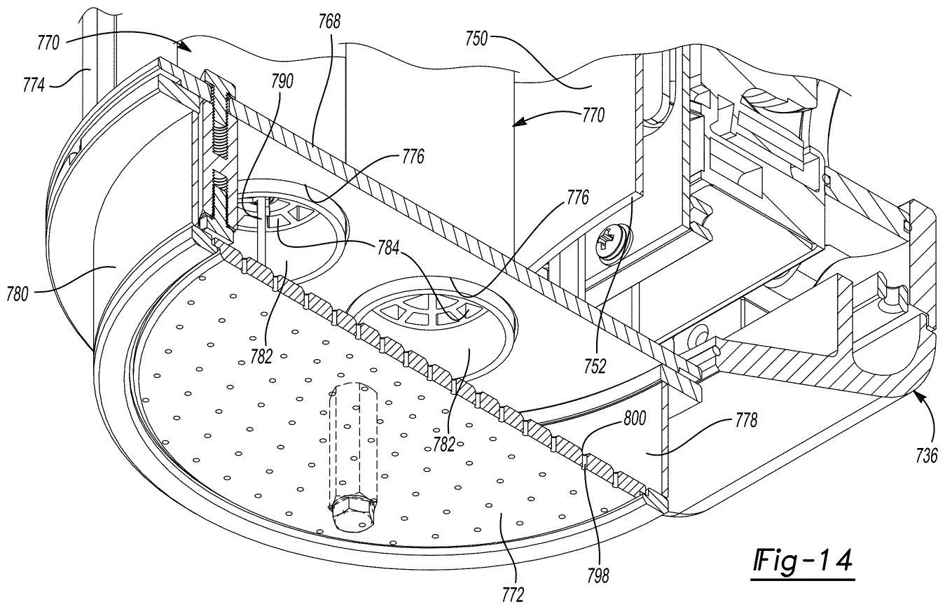

The heater assembly 732 may include a base plate 768, a plurality of heating elements 770, and an impingement plate 772. The base plate 768 may be fixed within the heater housing 738 between the opening 752 and the second axial end 749. The base plate 768 may sealingly engage an inner diametrical surface 739 of the heater housing 738 (as shown in FIG. 13) to form a sealed barrier separating the internal cavity 746 of the heater housing 738 from the open second axial end 749 of the heater housing 738. The base plate 768 mounted to the heater housing 738 by a plurality of support columns 774. The base plate 768 may include a plurality of apertures 776 each of which may be aligned with a respective one of the heating elements 770. As shown in FIGS. 13 and 14, the heating elements 770 may extend through the apertures 776 into a space 778 between the base plate 768 and the impingement plate 772. An annular collar 780 may extend axially from the base plate 768 to the impingement plate 772 to enclose the space 778.

Each of the heating elements 770 may include an outer housing 782 and a heating core 784. The outer housing 782 may be tubular and may extend though the apertures 776 in the base plate 768. The outer housings 782 may be press fit or otherwise fixedly received into the apertures 776. A bracket 786 may engage the heating elements 770 to retain the heating elements 770 relative to each other. While not shown in the figures, a support structure (e.g., one or more beams and/or fasteners) may fix the bracket 786 to the heater housing 738.

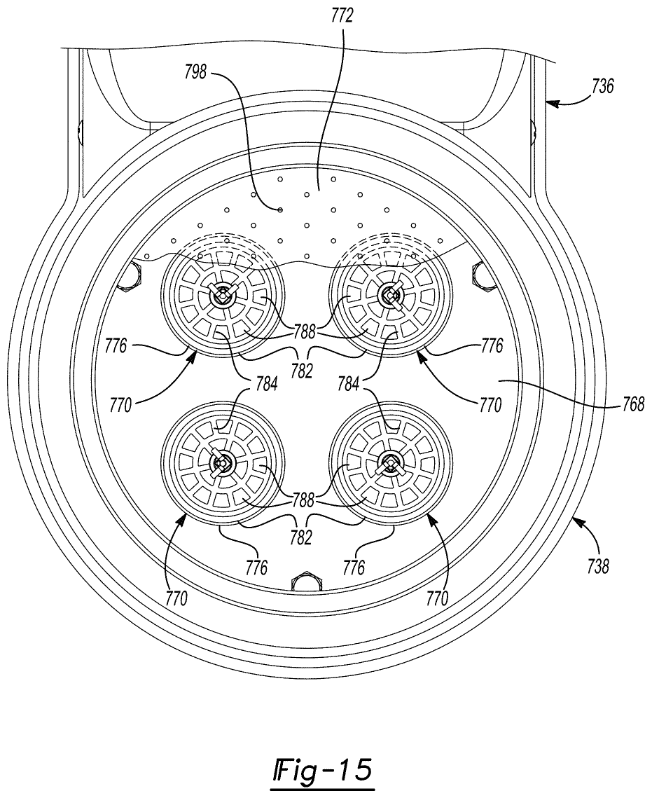

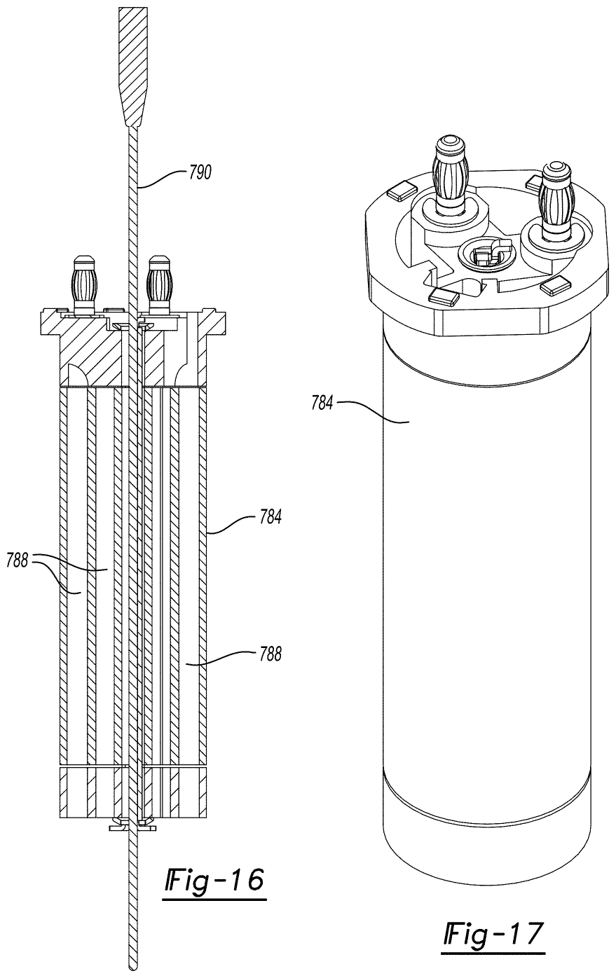

As shown in FIGS. 15 and 16, each of the heating cores 784 may include a plurality of airflow passages 788 extending therethrough. In this manner, air in the internal cavity 746 of the heater housing 738 can flow through the airflow passages 788 to the space 778 between the base plate 768 and the impingement plate 772. In some configurations, the heating cores 784 may be formed from a ceramic material. Resistance heating wires (e.g., wire coils) can be wrapped around and/or through the heating cores 784. When provided with electrical current, the heating wires heat the heating cores 784. In this manner, air flowing through the airflow passages 788 is heated by the heating cores 784 and heating wires.

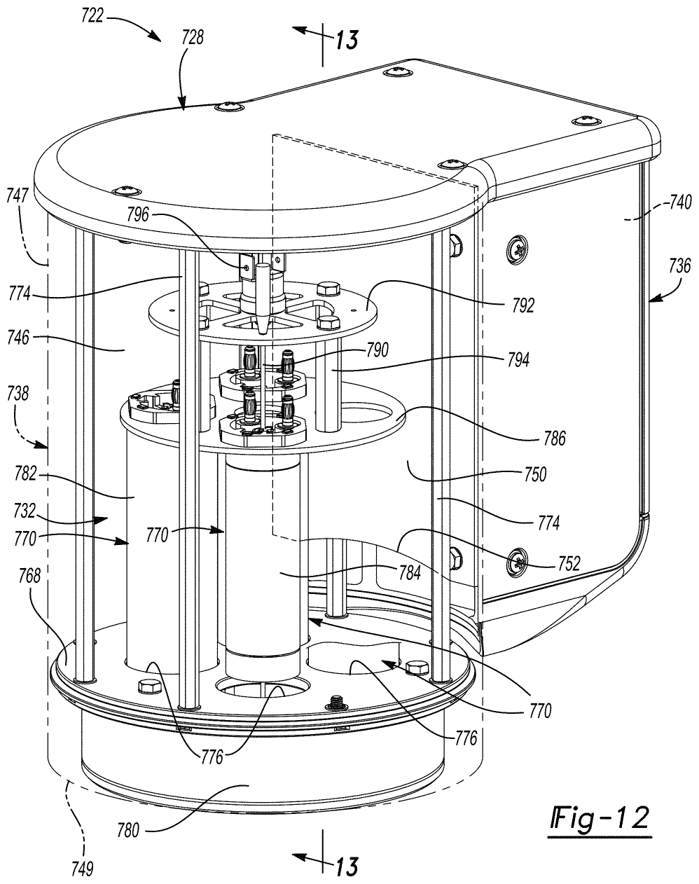

As shown in FIGS. 12 and 16, a temperature sensor 790 (e.g., a thermistor, thermocouple, or a resistive temperature detector) may extend through one of the heating cores 784. As shown in FIGS. 11 and 14, the temperature sensor 790 may extend into the space 778 between the base plate 768 and the impingement plate 772. This allows the temperature sensor 790 to obtain accurate measurements of the heated air before the air exits the food-heating apparatus 722. The temperature sensor 790 may be supported by a bracket 792 that may be mounted to the bracket 786 by support columns 794. The bracket 792 may also support an electrical terminal 796 that may be electrically connected to the heating wires of the heating elements 770 and a source of electrical power.

The impingement plate 772 may be a generally circulate plate and may define an outlet of the food-heating apparatus 722. As shown in FIGS. 11, 13, and 14, the impingement plate 772 includes a plurality of apertures or perforations 798 extending therethrough. In some configurations, the apertures 798 are more concentrated (i.e., positioned closer together and in greater numbers) toward the center of the impingement plate 772. In other configurations, the apertures 798 are generally evenly distributed. In some configurations, ends of the apertures 798 adjacent to the space 778 may include chamfers 800 (as shown in FIG. 14). The chamfers 800 may improve airflow through the impingement plate 772.

In some configurations, the food-heating apparatus 722 may include an air filter (not shown) that filters the air before entering the blower assembly 730. In some configurations, the filter may be disposed along the airflow path through the food-heating apparatus 722 between the air inlet aperture 742 and the impingement plate 772 of the heater assembly 732. In some configurations, the filter may be disposed at the impingement plate 772 of the heater assembly 732 or downstream of the impingement plate 772 of the heater assembly 732.

During operation of the food-heating apparatus 722, the motor 758 of the blower assembly 730 may drive the fan 754 to draw air into the blower assembly 730 through the inlets 742, 760. The air is discharged from the blower assembly 730 through the outlet 762 and is directed through the opening 752 and into the internal cavity 746 of the heater housing 738. From the opening 752, the air is forced up through the internal cavity 746 and around the outside of the heating elements 770 (i.e., outside of the outer housings 782 of the heating elements 770). The air may be warmed as it flows up through the internal cavity 746 and around the outside of the heating elements 770. The air is then forced through the airflow passages 788 in the heating cores 784, where the air is more substantially heated. The air exits the heating elements 770 and flows into the space 778 before exiting the food-heating apparatus 722 through the apertures 798 in the impingement plate 772.

By channeling the air up through a first flow path through the internal cavity 746 around the outside of the heating elements 770 and then down a second flow path through the heating elements 770 (rather than simply channeling the air in a more direct route from the blower assembly 730 through the heating elements 770) the heater housing 738 can be constructed without single-purpose insulation, thereby resulting in a net lower thermal mass system. This may decrease the amount of time needed to warm up the food-heating apparatus 722 for use and decrease the amount of time needed to cool down the food-heating apparatus 722 after use.

The food-heating apparatus 722 may be controlled in a manner that is similar or identical to that of the food-heating apparatus 22 described above. Therefore, the control of the food-heating apparatus 722 will not be described again.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

As used herein, the phrase at least one of A, B, and C should be construed to mean a logical (A OR B OR C), using a non-exclusive logical OR, and should not be construed to mean “at least one of A, at least one of B, and at least one of C.” The term subset does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A food-heating apparatus comprising:
a blower assembly;
a heater housing receiving air from the blower assembly; and
a heating element disposed within the heater housing,
wherein:
the heater housing defines a first flow path through which the air flows in a first direction outside of the heating element,
the heating element defines a second flow path through which the air flows in a second direction inside of the heating element, and
the first flow path receives the air from the blower assembly, and the second flow path receives the air from the first flow path.

2. The food-heating apparatus of claim 1, wherein the blower assembly is disposed within a blower housing that is attached to the heater housing.

3. The food-heating apparatus of claim 1, wherein the food-heating apparatus includes a plurality of heating elements defining the second flow path.

4. The food-heating apparatus of claim 1, further comprising an impingement plate including a plurality of apertures, wherein the impingement plate defines an air outlet of the food-heating apparatus.

5. The food-heating apparatus of claim 2, wherein a partition plate is disposed between the heater housing and the blower housing and defines an opening that provides fluid communication between the blower assembly and the first flow path.

6. The food-heating apparatus of claim 1, wherein the heating element includes an outer housing and a heating core disposed within the outer housing.

7. The food-heating apparatus of claim 6, wherein the heating core defines an airflow passage that at least partially defines the second flow path.

8. The food-heating apparatus of claim 7, further comprising:
an impingement plate including a plurality of first apertures and defining an air outlet of the food-heating apparatus; and
a base plate including a second aperture aligned with the outer housing,
wherein:
the base plate fluidly separates the first flow path from the impingement plate, and
the second aperture allows fluid communication between the heating element and the impingement plate.

9. The food-heating apparatus of claim 8, wherein a space between the base plate and the impingement plate receives air from the heating element.

10. The food-heating apparatus of claim 9, further comprising:
a temperature sensor at least partially disposed in the space between the base plate and the impingement plate,
wherein the temperature sensor extends through the heating element and into the space.

11. A food-heating apparatus comprising:
a fan;
a heater housing defining an internal cavity that receives air from the fan; and
a heating assembly including a plurality of heating elements, a base plate, and an impingement plate,
wherein:
the base plate engages the heating housing and closes off an end of the internal cavity,
the base plate separates the internal cavity from a space between the base plate and the impingement plate,
the heating elements are mounted to the base plate and at least partially disposed within the internal cavity, and
the heating elements receive air from the internal cavity and channel the air to the space between the base plate and the impingement plate.

12. The food-heating apparatus of claim 11, wherein:
the heater housing defines a first flow path in the internal cavity outside of the heating elements, and
the heating elements define a second flow path through which the air flows through the heating elements to the space between the base plate and the impingement plate.

13. The food-heating apparatus of claim 11, wherein the fan is disposed within a blower housing that is attached to the heater housing.

14. The food-heating apparatus of claim 13, further comprising:
a partition plate disposed between the heater housing and the blower housing,
wherein the partition plate defines an opening that provides fluid communication between the fan and the internal cavity of the heater housing.

15. The food-heating apparatus of claim 11, wherein the impingement plate includes a plurality of apertures and defines an air outlet of the food-heating apparatus.

16. The food-heating apparatus of claim 11, wherein:
each of the heating elements includes an outer housing and a heating core disposed within the outer housing,
each of the heating cores defines an airflow passage that is separate from the airflow passage of the other of the heating cores, and
the air flow passages provide fluid communication between the internal cavity and the space between the base plate and the impingement plate.

17. The food-heating apparatus of claim 16, wherein the space between the base plate and the impingement plate receives air from the airflow passages of all of the heating cores.

18. The food-heating apparatus of claim 17, wherein the base plate includes a plurality of apertures each of which receives a respective one of the heating elements to allow fluid communication between the heating elements and the space between the base plate and the impingement plate.

19. The food-heating apparatus of claim 11, further comprising a temperature sensor at least partially disposed in the space between the base plate and the impingement plate.

20. The food-heating apparatus of claim 19, wherein the temperature sensor extends through one of the heating elements and into the space.
